(19) United States
(12) Patent Application Publication
(10) Pub. No.: US 2010/0114988 A1
(43) Pub. Date: May 6, 2010

(54) JOB COMPETENCY MODELING

(76) Inventors: Andrew Linn, Auburndale, MA (US); Douglas W. Crisman, Princeton, NJ (US); Kelly McKiernan, Weymouth, MA (US); G. Kent Plunkett, Wellesley, MA (US); Stephen Schoonover, Cataumet, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/477,073

(22) Filed: Jun. 2, 2009

Related U.S. Application Data
(60) Provisional application No. 61/057,894, filed on Jun. 2, 2008.

(51) Int. Cl. G06F 17/30

(52) U.S. Cl. 707/805; 707/803; 707/802; 707/E17.005

(57) ABSTRACT

An apparatus for managing a job model workflow, the apparatus including a server computer including a processor and associated memory, a data store, the server computer connected to the data store and configured to execute computer readable instructions that, when executed, cause the server computer provide an application that can: receive from a user a request to create a job model, create a job model data structure in the data store corresponding to the job model, populate the data structure with a first data object representing one or more attributes of the job model, notify another user that feedback relating to the one or more attributes of the job model is requested, provide an interface for the another user to provide feedback, store received feedback in the data store, and provide the received feedback to the user.

### CROSS-REFERENCE TO RELATED ACTIONS

This application claims the benefit of, and priority to prior U.S. Provisional Application No. 61/057,894, filed Jun. 2, 2008, which is incorporated by reference herein in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Competency management systems have been traditionally used in the context of specific consulting services that are prepared at the request of employers as an adjunct to existing talent management systems. These competency management systems are typically developed downstream of pre-defined job models and are imported into those pre-defined job models. Many competency management consulting services work with clients to modify a pre-existing job model through a time consuming manual drafting process in which all of the stakeholders of the model are in the same room to discuss and review the changes to the model. Current human resource systems typically do not provide consistent competency information across multiple applications and none allow the custom authoring of job competency models nor provide a system to manage the workflow associated with that process.

### SUMMARY

In general, in an aspect, the invention provides an apparatus for managing a job model workflow, the apparatus including a server computer including a processor and associated memory, a data store, the server computer connected to the data store and configured to execute computer readable instructions that, when executed, cause the server computer provide an application that can: receive from a user a request to create a job model, create a job model data structure in the data store corresponding to the job model, populate the data structure with a first data object representing one or more attributes of the job model, notify another user that feedback relating to the one or more attributes of the job model is requested, provide an interface for the another user to provide feedback, store received feedback in the data store, and provide the received feedback to the user.

Implementations of the invention may provide one or more of the following features. The one or more attributes are representative of a competency. The one or more attributes are representative of a plurality of competencies and wherein the computer readable instructions cause the server computer to provide an application that can notify the another user that feedback is requested with respect to a subset of the plurality of competencies. The data store includes a data structure including information representing a job model template, wherein the computer readable instructions cause the server computer to provide an application that can populate the job model data structure using at least part of the information representing the job model template. The computer readable instructions cause the server computer to provide an application that can provide the user with the ability to define the feedback requested from the another user.

Implementations of the invention may also provide one or more of the following features. The computer readable instructions cause the server computer to provide an application that can provide the user with the ability to create a polling question relating to the attributes. The computer readable instructions cause the server computer to provide an application that can finalize the job model. The computer readable instructions cause the server computer to provide an application that can publish at least a portion of the job model. The computer readable instructions cause the server computer to provide an application that can provide the user with the ability to revise the attribute as a function of the received feedback. The computer readable instructions cause the server computer to provide an application that can notify the another user that feedback relating to the revised attribute is requested.

In general, in another aspect, the invention provides a computerized method relating to a job model, the method including providing a sever computer, associated memory, and a data store coupled to the server computer, creating a data structure related to the job model in the data store, populating the data structure with a first data object representing an attribute of the job model, creating a feedback request requesting feedback relating to the attribute, receiving feedback relating to the attribute, updating the data structure to include a second data object representing the received feedback, updating the first data objects as a function of the received feedback, and publishing at least a portion of the data structure to an application.

Implementations of the invention may provide one or more of the following features. The attribute is representative of a competency. The attribute is a plurality of competencies and the creating the feedback request includes requesting feedback relating to a subset of competencies. The computerized method further includes maintaining a second data structure in the data store that includes information representing a job model template. Populating the data structure includes populating the data structure using at least a portion of the information contained in the second data structure. The computerized method further includes defining the requested feedback. Defining the requested feedback includes creating a polling question relating to the attribute. Populating the data structure with a third data object that reflects a status of the job model.

In general, in another aspect, the invention provides a computer readable medium for storing data for access by an application program executed on a processor, the computer readable medium including a data structure stored in the computer readable medium, the data structure relating to a job model and including information used by the application program including a first data object representing an identifier associated with the job model, a second data object representing a competency associated with the job model, a third data object representing a subattribute associated with the competency, and a fourth data object representing a level of completion associated with the job model.

Implementations of the invention may provide one or more of the following features. The level of completion is at least one of draft, validation in process, validated, approval in process, approved, declined, and archived. A fifth data object representing feedback received from a user relating to at least one of the competency and the subattribute. The fourth data object is updated in response to receiving feedback from a user. A sixth data object representing publication information related to the subattribute.

In general, in another aspect, the invention provides an apparatus for managing a job model workflow, the apparatus including a server computer including a processor and associated memory, the server computer hosting an application, a data store coupled to the server, a client computer including a processor and associated memory coupled to the server computer through a network, the client computer being configured to execute computer readable instructions that, when executed, cause the client computer to access the server computer, wherein the server computer executes computer readable instructions that, when executed, cause the server computer to provide an application that can receive from a user a request to create a job model, create a job model data structure in the memory corresponding to the job model, populate the data structure with a first data object representing one or more attributes of the job model, notify another user that feedback relating to the one or more attributes of the job model is requested, provide an interface for the another user to provide feedback, store received feedback in the memory, and provide the received feedback to the user.

Various aspects of the invention may provide one or more of the following capabilities. Organizations can design, create, validate, implement, and manage competency models for use in one or more human resources applications. Organizations can manage a workflow process associated with the development and approval of competency models. Rapid prototyping and implementation of job models is possible. Working groups, stakeholders, and approvers can provide feedback regarding newly created job models. Job model maintenance and update procedures can be automatic. Job category and competency requirements can be created and managed. A job model can be associated with one or more competency supporting data sets that support human resources applications that utilize job competency models.

These and other capabilities of the invention, along with the invention itself, will be more fully understood after a review of the following figures, detailed description, and claims.

### BRIEF DESCRIPTION OF THE FIGURES

FIG. 1 is a block diagram of a computer system that can be configured to implement a job model management system.

FIG. 2 is a flow chart of a process for managing a job model.

FIG. 3 is a flow chart of a process for creating/authoring a job model.

FIG. 4 is a flow chart of a process for confirming a job model.

FIG. 5 is a flow chart of a process for approving a job model.

FIG. 6 is a flow chart of a process for publishing a job model.

FIG. 7 is a block diagram illustrating publication of a job model.

FIG. 8 is a flow chart of a process for updating competencies.

### DETAILED DESCRIPTION

Embodiments of the invention provide methods and systems for job model creation. The user can initiate and create a job model relating to a specific job that includes identifying and associating one or more relevant job competencies. The user can select the competencies manually and/or can use a predefined template contained in a library. The job model creation workflow described herein can provide the user with the ability to seek multi-tiered feedback from one or more groups of people. First, the user can solicit feedback from workgroup members (e.g., peers) while creating a job model and defining its attributes. Second, the user can solicit feedback from stakeholders (e.g., peers, subject matter experts, and immediate managers) before seeking final approval. Third, the user can also solicit feedback and final approval from upper-level management (e.g., C-Level employees and/or outside legal counsel) before finalizing and publishing a job model to other applications.

Embodiments of the invention can also provide techniques for managing multiple job models. The user can view a list of all available job models that have been created, and/or are in the process of being created. Status information relating to each of the job models can include whether a particular job model is a draft, in the process of being validated, has been validated, in the process of being approved, approved, finalized, and/or published. Other embodiments are within the scope of the invention.

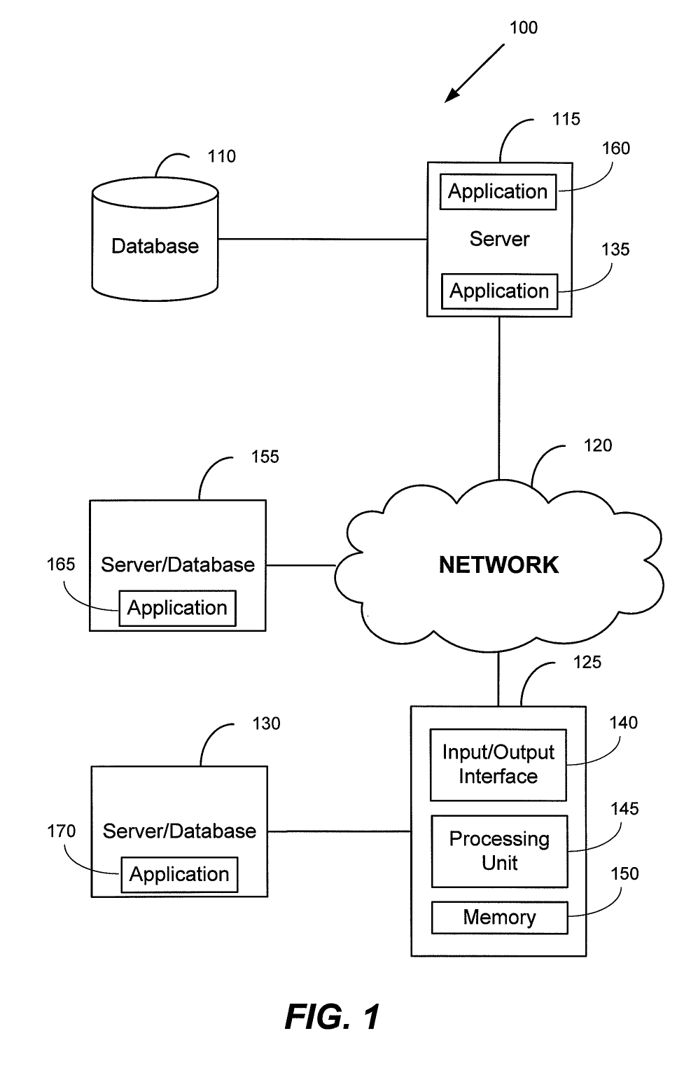

FIG. 1 shows an embodiment of a system according to the present invention. Referring to FIG. 1, a system 100 can include a server 115 configured to provide access to one or more applications and a database 110. The server 115 can be coupled to a network 120 to allow access to one or more of the applications by a user using a client computer 125 connected to the network 120. Typically, the database 110 and the server 115 can be remotely located from the client computer 125, and the server 115 and the database 110 need not be in the same location. For example, the database 110 and the server 115 can be hosted by a service provider that is in one location, and the computer 125 can be remotely located within a corporate network of a subscriber (e.g., a company that purchased access to the applications hosted by the server 115, Software as a Service). Additional servers, databases, and/or applications can be used in conjunction with the system 100. In one embodiment of the invention, a server/database 130 can be connected to the computer 125 to provide the user with access to additional applications. In another embodiment of the invention, a server/database 150 can be connected to the network 120, thereby making it accessible to the server 115 and/or the computer 125.

The database 110 can be a data store that can store a library of information that can be used by the server 115 and the applications to create and modify job models. In one embodiment of the invention, the database 110 can store a library of job model templates that can be used by the server 115 and the application (and ultimately a user of the computer 125):

TABLE 1
Library

Job model template 1
Job model template 2
Job model template 3
Job model template 4
Job model template 5
. . .
. . .
Job model template n−1
Job model template n

Each of the job model templates can be associated with a specific job type (e.g., Accountant, Underwriter, Attorney I, Attorney II) and preferably includes one or more attributes (e.g., job title, job function, job description, job level, behavior statements, writing assistances, learning references, coaching tips, goal statements, interview questions, and competencies). Each job model template stored within the library can be a separate file or separate data structure. In one embodiment of the invention, each of the job model templates stored in the database 110 includes the following:

TABLE 2
Job Model Template Data Structure

Template
Framework
Model Type
Model Title
Model ID
Job Function
Job Level
Job Focus
Job Responsibilities
Additional User Defined Attributes
Tags associated with the Template
Competencies
Subattributes Related to Competencies
(e.g., proficiency targets such as
recommended proficiency, recommend
weight, and recommended importance)

Each of the competencies can be stored in a competency library and can be stored in a separate file and/or data structure. Each competency can also include additional subattributes that can be specific to a particular job model. For example, certain of the subattributes included within each competency can be customized to reflect a recommended value that relates to a particular job model template. An exemplary data structure is configured as follows:

TABLE 3
Competency Subattributes

Name
Competency Class
Competency Type
Competency Definition
Competency Cluster
Source
Behavioral Statements (e.g., grouped by
proficiency level)
Writing Assistance
Coaching Tips
Learning References
Goal Statements
Interview Questions

Furthermore, certain of the subattributes can include additional subfields that indicate, for example, which applications a particular can be published to (e.g., during the publication stage, the “writing assistance” subattribute may only be published to certain other applications that use this type of information).

The server 115 is preferably a computer configured to provide one or more web-based applications, although other types of software applications and/or data can be hosted. The server 115 can be connected to the database 110 via a network connection (e.g., a direct network connection behind a corporate firewall). The server 115 can be a commercially available server such as a POWEREDGE server manufactured by Dell Corporation of Round Rock, Tex., although other types of computers can be used as the server 115. The database 110 can be a commercially available network storage device such as an EQUALLOGIC storage area network manufactured by Dell Corporation of Round Rock, Tex., although other types of devices can be used as the database 110.

In accordance with one embodiment of the invention, the server 115 can execute computer readable instructions that cause the server 115 to operate in accordance with the present invention. The computer readable instructions can be stored in, for example, a memory of the server 115, the database 110, and/or a remotely located computer. The server 115 can be configured to provide web-based software applications to users of the computer 125 via the network 120. For example, the server 115 can be configured to execute a competency manager application 135 as described herein. In one embodiment of the invention, the server 115 can be configured to provide the competency manager application 135 using a client/server architecture as a subscription and/or SaaS service. For example, a user can log on to a web-based competency manager application 135 hosted on the server 115 using the computer 125 via the network 120.

The computer readable instructions executed by the server 115 can be configured to provide a workflow that manages one or more users through a process of creating a job model, including stakeholder and management review of the job model. For example, a user of the computer 125 can create a new job model by using, at least in part, one of the job model templates stored in the library on the database 110. The user can create the new job model using a collaborative process that is coordinated using the competency manager application 135 hosted by the server 115. The competency manager application 135 can include collaboration functionality that allows other users to review and post comments about the new job model, vote on the new job model, respond to poll questions, accept/reject a job model, recommend modifications to the job model on a competency-by-competency basis. The competency manager application 135 hosted by the server 115 can be configured such that once collaboration regarding the new job model has concluded (e.g., once confirmation and approval have been obtained, as described below), the user can finalize the new job model and publish the new job model to other applications and/or systems. The competency manager application 135 can export the job model in a standardized format in order to be imported into other applications. The functionality summarized in this paragraph is described more fully below.

The network 120 can provide network communication between the server 115 and the computer 125. The network 120 can be the Internet, although other networks can be used such as a LAN, WAN, wireless network, and an intranet. The systems and methods described herein are not limited to the architecture shown in FIG. 1. For example, in certain embodiments, the database 110, the server 115, the computer 125, and the database 130 can all be operated within a single corporate network.

The computer 125 can be any device that is capable of accessing a hosted service and/or application such as a commonplace personal computer. The computer 125 can include at least an input/output interface 140, a processing unit 145, and a memory 150. The computer 125 can include one or more applications that allow a user to access applications hosted by the server 115. For example, the computer 125 can be configured to execute proprietary applications used to access the server 115 and/or a standard web browsing application such as MOZILLA FIREFOX, MICROSOFT INTERNET EXPLORER, and/or GOOGLE CHROME. Using the web browser application, the user can access one or more web-based applications hosted by the server 115. While the computer 125 has been described as being a personal computer, other devices can be used such as a network terminal, a smartphone (e.g., blackberry, mobile phone), and a personal digital assistant.

The computer 125 can also operate (or be used to access) other human resources-related services and/or applications (e.g., applications 160, 165, 170) that can be used in conjunction with the competency manager application 135 hosted by the server 115. The applications 160, 165, 170 can include other applications such as a talent management application. As shown in FIG. 1, the applications 160, 165, 170 can be hosted in one or more locations such as the server 115, the server/database 130, and/or the server/database 150. One or more of the applications 160, 165, 170 can use at least part of each job model created using the competency manager application 135. For example, a performance review application can be configured to use a subset of the competencies contained within a job model to assist in a performance review process.

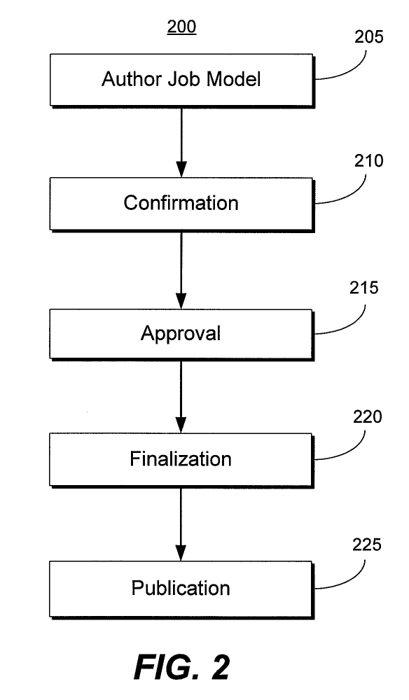

Each job model used with the competency manager application 135 can have one or more data structures associated with it. The creation of the respective data structures is discussed in more detail below with respect to FIGS. 2-6. An exemplary job model data structure is configured as follows:

TABLE 4

| Field | Exemplary Values |
|---|---|
| Job Model Name | General Counsel |
| | Housekeeper |
| | Actuary |
| Framework | Banking |
| | Customer Relationship Functions |
| | General Corporate Functions |
| | Healthcare Administration |
| | Information Technology |
| | Insurance |
| | Manufacturing |
| | Retail |
| | Software Industry |
| Model Type | Job |
| | Job Function |
| | Job Level |
| | Location |
| Job Title | Attorney |
| | Account Executive |
| | Assistant |
| Default Model | Yes/No |
| Job Description | Provides legal advice to an organization, |
| | prepares resolutions and forms, and |
| | participates in major legal actions. |
| Job Function | Legal Services |
| | Actuarial |
| | Financing and Accounting |
| Job Level | Executive Management |
| | First Line Management |
| | Management |
| | Senior Management |
| | Technician |
| | Team Leadership |
| | Technician, Trainee, Administrator |
| Job Responsibility 1 | Responsible for foreseeing and protecting |
| | the company against legal risks. |
| Job Responsibility 2 | Coordinates proactive completion of |
| | discovery as a case may require, i.e., |
| | interrogatories, request for production of |
| | documents, depositions. |
| Primary Job Focus | Business |
| | Mostly Administrative |
| | Mostly Technical |
| | Mostly Management |
| Secondary Job Focus | Business |
| | Mostly Administrative |
| | Mostly Technical |
| | Mostly Management |
| Public Tags | Attorney |
| Competencies | Knowledge of Organization |
| | Products and Services |
| | Business Ethics |
| | Active Learning |
| | Interpersonal Relationships |
| | Problem Solving |
| Status | Draft |
| | Validation in Process |
| | Validated |
| | Approval in Process |
| | Declined |
| | Approved |
| | Archived |
| Workgroup Data Structure | Contains Workgroup Members |
| | See Workgroup Substructure Below |
| Confirmation Data | See Confirmation Substructure Below |
| Structure | |
| Approval Data Structure | See Approval Substructure Below |
| Locked | Yes/No |
| Finalized | Yes/No |
| Archived | Yes/No |
| Applications to Publish To | Talent Management System (e.g., |
| | TALENTMANAGER provided by |
| | Salary.com of Needham, MA) |
| | Applicant Tracking System |
| | Performance Management System |
| | Learning Management System |
| | Competency Management System |
| | Workforce Planning System |
| | Career Planning System |
| | Succession Planning System |
| | And other applications that use |
| | competencies and/or job models |

An exemplary workgroup data substructure is configured as follows:

TABLE 5

| Workgroup Member | Corresponding Data |
|---|---|
| George Washington | Assigned Competencies (e.g., list of |
| | assigned competencies) |
| | Date Feedback Provided |
| | Feedback Content |
| John Adams | Assigned Competencies (e.g., list of |
| | assigned competencies) |
| | Date Feedback Provided |
| | Feedback Content |
| Franklin Pierce | Assigned Competencies (e.g., list of |
| | assigned competencies) |
| | Date Feedback Provided |
| | Feedback Content |

An exemplary confirmation data structure is configured as follows:

TABLE 6

| Stakeholder | Corresponding Data |
|---|---|
| Ben Franklin | Assigned Competencies and/or Models |
| | (e.g., list of assigned competencies |
| | and/or models) |
| | Date Feedback Requested |
| | Date Feedback Request Opened |
| | Feedback provided (e.g., Yes/No) |
| | Date Feedback Provided |
| | Notification Sent (e.g., Yes/No) |
| | Feedback Content |
| Abraham Lincoln | Assigned Competencies and/or Models |
| | (e.g., list of assigned competencies |
| | and/or models) |
| | Date Feedback Requested |
| | Date Feedback Request Opened |
| | Feedback provided (e.g., Yes/No) |
| | Date Feedback Provided |
| | Notification Sent (e.g., Yes/No) |
| | Feedback Content |

An exemplary approval data structure is configured as follows:

TABLE 7

| Approver | Corresponding Data |
|---|---|
| Franklin Roosevelt | Assigned Competencies and/or Models |
| | (e.g., list of assigned competencies |
| | and/or models) |
| | Date Feedback Requested |
| | Date Feedback Request Opened |
| | Feedback provided (e.g., Yes/No) |
| | Date Feedback Provided |
| | Notification Sent (e.g., Yes/No) |
| | Feedback Content |
| Calvin Coolidge | Assigned Competencies and/or Models |
| | (e.g., list of assigned competencies |
| | and/or models) |
| | Date Feedback Requested |
| | Date Feedback Request Opened |
| | Feedback provided (e.g., Yes/No) |
| | Date Feedback Provided |
| | Notification Sent (e.g., Yes/No) |
| | Feedback Content |

Other configurations of the preceding data structures are possible.

In operation, referring to FIG. 2, with further reference to FIG. 1, a process 200 for managing a job model creation workflow using an application hosted by the server 115 can include the stages shown. The process 200, however, is exemplary only and not limiting. The process 200 may be altered, e.g., by having stages added, removed, altered, or rearranged. Throughout the description of the remaining figures, it is assumed that a user is accessing the web-based competency manager application 135 hosted by the server 115 using the computer 125. As described herein, however, this configuration is exemplary only and not limiting. For example, the competency manager application 135 can an applicant hosted on the computer 125. Furthermore, exemplary screen shots of certain aspects of the process 200 are attached hereto as an appendix.

At stage 205, a user that has been granted the appropriate permission can access the competency manager application 135 using the computer 125. The user can edit existing job models and/or create new job models. If the user chooses to edit an existing job model, the job model can be retrieved from memory. If the user chooses to create a new job model, the job model can be created manually and/or using information provided by the competency manager application 135 (e.g., from a job model template provided by the competency manager application 135). The competency manager application 135 can be configured to create a new job model data structure for each job model that is created by the user.

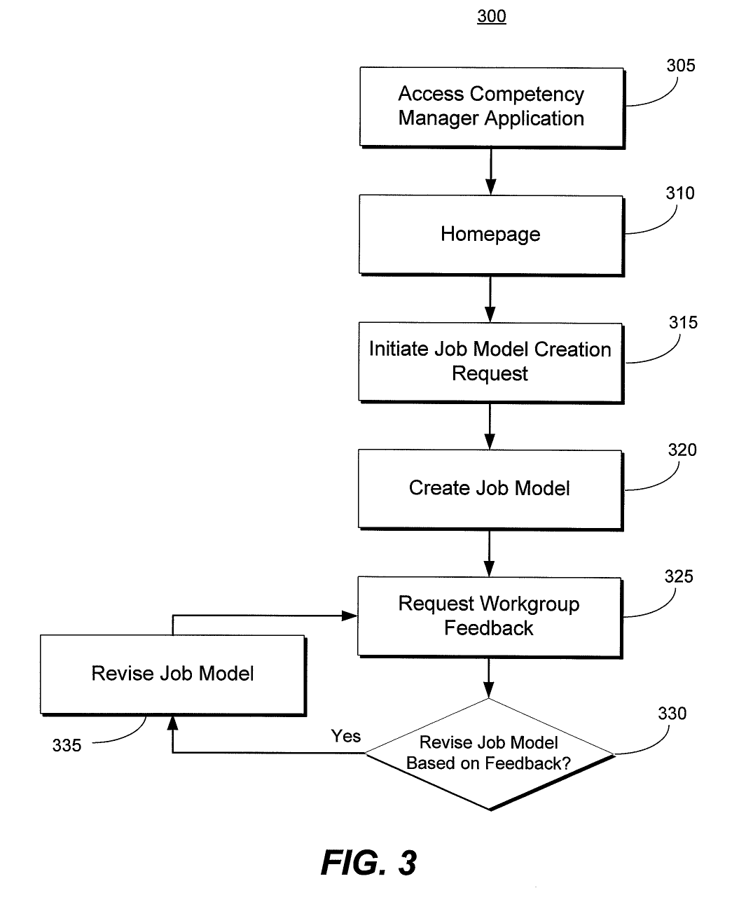

The competency manager application 135 can manage a workflow to collaborate with a workgroup (e.g., peers). The competency manager application 135 can allow the members of the workgroup to review, comment, and revise the job model on a competency-by-competency basis. Collaboration received from the other workgroup members can include written feedback to questions posed by the user, responses to polls created by the user, and/or other feedback provided by the workgroup members. Stage 205 is discussed further below with respect to FIG. 3.

Job models are job-specific definitions that include one or more attributes that preferably relate to a specific job. Job models can be used as a guidepost to define an ideal candidate for a specific job. For example, job models can include attributes that relate to a specific job. Typical job models include a framework, a model type, a title, a job function, a job level, a job focus, job responsibilities, user defined fields, a title of a job (e.g., Accountant I), a job level (e.g., I, II, III, etc.), one or more competencies, a competency proficiency target, and competency attributes (e.g., behavioral statements, writing assistances, learning references, coaching tips, goal statements, and interview questions). Other attributes can also be included in a particular job model.

Competencies are the desired groupings of knowledges, skills, and/or abilities that can, through observable behavior, define the attributes of a particular individual to meet the requirements of a specific job. Competencies can be grouped into categories such as leadership, core, and functional (which can also include technical competencies). Competencies can vary widely depending on the nature of a particular position. Examples of leadership competencies for an accountant include judgment, decision making, analytic thinking, and problem solving. Examples of core competencies for an accountant can include business acumen, quick learner, agile, flexibility, business math, confidentiality, consulting, decision-making, critical thinking, and effectiveness measurement. Examples of functional competencies for an accountant include Microsoft Office Suite, business knowledge, budget management, collections, cost accounting, and financial analysis.

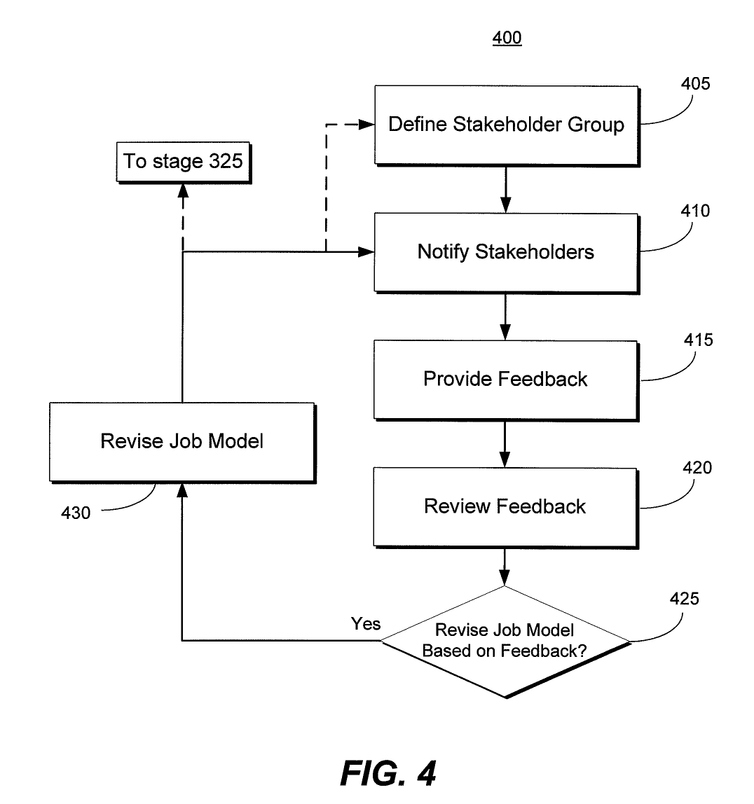

At stage 210, the competency manager application 135 can manage the process of confirming a job model. Confirmation of a job model can be performed by stakeholders such as subject matter experts, managers and department heads, although other stakeholders are possible. For example, the user can seek feedback from one or more stakeholders relating to part or all of a particular job model. Examples of feedback from the stakeholders can include written/answers feedback to questions posed by the user, responses to polls created by the user, recommended values for attributes contained in the job model, and/or other feedback provided by the stakeholders. The competency manager application 135 can be configured to prevent the user from advancing to later stages until all requested feedback has been provided. Stage 210 is discussed further below with respect to FIG. 4.

At stage 215, the competency manager application 135 can manage the process of approving a job model. Approval of a job model can be performed by senior-level decision-makers such as chief executive officers, chief information officers, and general counsel, although outside approvers can be allowed to participate (e.g., outside consultants and outside legal counsel). Approval can include the user requesting a yes/no approval from one or more approvers. Additionally, the approvers can also provide additional written feedback through the competency manager application 135.

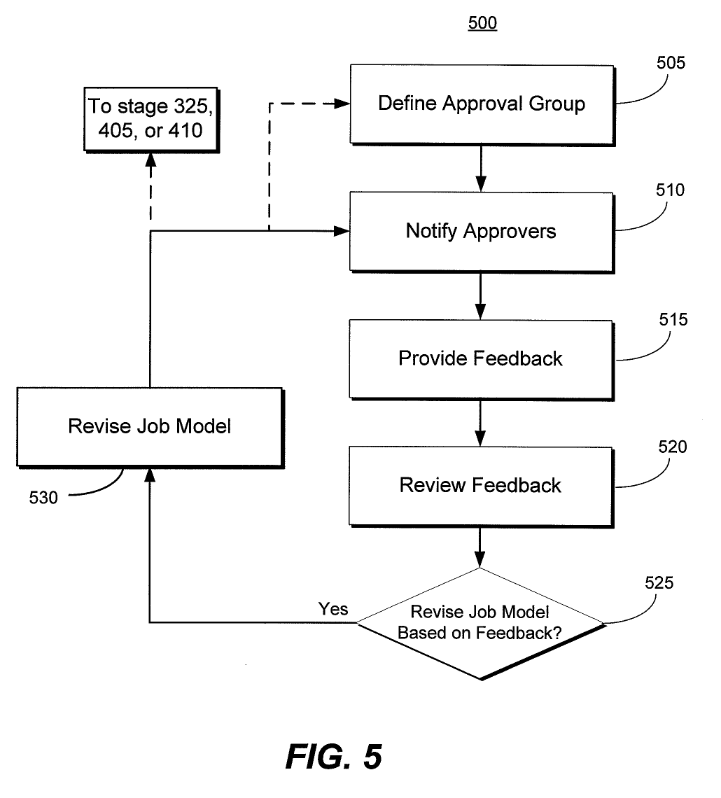

The competency manager application 135 can be configured to prevent the user from finalizing and/or publishing the job model until all of the requested approvals have been obtained. In other embodiments of the invention, the competency manager application 135 can be configured to allow the user to proceed to later stages once a certain percentage of approvers have approved the job model (e.g., when three of five approvers have approved the job model). Stage 215 is discussed further below with respect to FIG. 5.

At stage 220, using the competency manager application 135, the user can finalize a job model. A job model can be finalized after all necessary confirmations and/or approvals have been obtained. A user can decide whether to lock the job model from further editing during the finalization stage. A locked job model can provide a permanent archive of the job model (e.g., for legal reasons). If a job model is not locked, the user can edit the job model at a later time. A user can also add tags to a particular job model while finalizing it in order to simplify later searching. Each of the actions described in this stage can be accomplished by changing a related data field in the job model data structure. Other actions are possible when finalizing a job model.

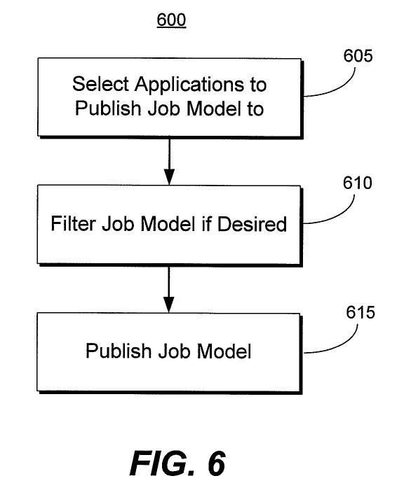

At stage 225, the competency manager application 135 can publish one or more job models (or subparts thereof) to other human resource applications such as talent management software and/or applications (e.g., applications 160, 165, 170). Publishing a job model can allow the other applications to use part and/or all of the job model created using the competency manager application 135. Publication of a job model preferably occurs once the job model has been approved (e.g., during stage 215) and finalized (e.g., during stage 220). While publication of a job model preferably occurs on a job model-by-job model basis, other configurations are possible (e.g., multiple job models can be published simultaneously). Stage 225 is discussed further below with respect to FIG. 6.

In operation, referring to FIG. 3, with further reference to FIGS. 1-2, a process 300 for creating/authoring a job model can include the stages shown. The process 300, however, is exemplary only and not limiting. The process 300 can be altered, e.g., by having stages added, removed, altered, or rearranged. As discussed above, the process 300 assumes that a user is accessing a web-based competency manager application hosted by the server 115 using the computer 125, although other configurations are possible. Furthermore, exemplary screen shots of certain aspects of the process 300 are provided in the attached Appendix A.

At stage 305, the user can access the competency manager application 135 using the computer 125. The user preferably accesses the competency manager application 135 using a web browser application provided by the computer 125. The user can log onto the competency manager application 135 by inputting a user ID and password, although other logon methods are possible. The competency manager application 135 can determine whether the user has permission to logon by consulting a data structure that includes a list of permissible users. The competency manager application 135 can also be configured to include a password recovery feature. While stage 305 is described in the context of accessing a web-based version of the competency manager application 135, other configurations are possible (e.g., the user can access the competency manager application 135 using a proprietary application).

At stage 310, upon accessing the competency manager application 135, the user is preferably presented with a homepage. The homepage is preferably a highly configurable webpage that can display appropriate information as a function of a level of access granted to the user. The competency manager application 135 can configure the homepage by consulting a homepage data structure associated with the user that identifies the desired content. Preferably, from the homepage the user can:
View tasks that require attention
View job models that have been created
Sort and/or filter created job models using predefined criterion
View job models that have been created by any user within an organization
View a listing of standard company configured competencies
View a listing of company values
Perform a quick search of job models and/or competencies
Access documents or websites provided by the user's company within a knowledge center
Access documents or white papers provided by the provider within a resource center
Access preferred websites the user has configured
Submit a request to initiate the creation of a job model
Perform administrative tasks (e.g., change a password)

At stage 315, the user can initiate a job model creation request by clicking the appropriate link on the homepage and is preferably presented with a job model creation request page. The competency manager application 135 can send one or more notifications (e.g., e-mails) to predetermined recipients when a new job model creation request is initiated. When initiating a job model creation request, the user can set one or more customizable high-level attributes related to the job model being initiated. For example, the user can be prompted to provide a job model type, a job model name, a job title, an organization group associated with the job model, a department associated with the job model, and a location associated with the job model. Furthermore, an user can also associate miscellaneous comments with the initiated job model request. Once a job model is initiated, it is preferably saved for later access by the user by creating a new job model data structure that includes the information provided by the user.

At stage 320, the user can create the job model by adding additional details. For example, the user can be prompted to select a framework (e.g., banking, customer relationship functions, general corporate functions, healthcare administration, manufacturing, and retail), a model type (e.g., job, job function, job level, location, organization, and position), a job function (e.g., legal services, housekeeping, food and nutrition, IT consulting, and IT security), a job model title, and a job title, each being stored in the related portion of the job model data structure. The user can also decide how to continue creating a new job model by, for example, creating a new job model, using a previously created model as a template, and/or using a library template provided by the competency manager application 135 (e.g., a library template hosted on the database 110). The user can also be prompted to add additional details about the job for which the job model is being created such as job description, job function, job level, job responsibilities, and job focus (e.g., mostly technical, mostly managerial, mostly administrative).

The competency manager application 135 can also be configured to allow the user to set the level of required review for the job model. The level of required review can be stored in the job model data structure. For example, the required level of review for the job model can include the following:

TABLE 8

Validation and Approval Required
Validation and Approval Optional
Validation Off and Approval Off
Validation On and Approval Off
Validation Off and Approval On

The competency manager application 135 can prompt the user to add one or more competencies that are associated with the particular job for which the job model is being created. Each competency to be added can be saved in the job model data structure. Competencies can vary widely depending on the specific job being created. For example, competencies can vary depending on a type of job (e.g., accountant versus paralegal), an experience level (e.g., an entry level accountant versus an experienced accountant), and a job location (e.g., downtown Manhattan versus rural Kansas). Competencies can be created from scratch, retrieved from previously created job models, and/or can be retrieved from pre-existing libraries provided by the competency manager application 135.

Each of the job models can also include competency subattributes that can be defined for a particular job model. Each competency within a job model can have one or more subattributes such as a competency class (e.g., core, functional, leadership), the competency type (e.g., intrinsic, extrinsic), a proficiency, a weight, and importance. Certain of the subattributes can be predefined and preferably cannot be changed (e.g., competency class and competency type), while other subattributes are definable by the user. Typically, the proficiency, weight, and importance subattributes can be definable by the user and can vary widely depending on the specific job model being created. The competency manager application 135 can store each of these of attributes in the job model data structure. Furthermore, the subattributes can be calibrated among multiple job models to, for example, avoid a scenario where a lower level employee has higher requirements than a senior level employee. Other subattributes are also possible.

The competency manager application 135 can allow the user to manually create the job model by adding individual competencies to the job model and by defining the competency subattributes. To do so, the user can manually search a library of competencies. For example, if the user determines that honesty is an important competency for a particular job model, the user can search for honesty-related competencies in the library. The competency manager application 135 can also allow the user to define new competencies. The user is also able to pick values for the subattributes such as proficiency and importance for each of the competencies added.

The competency manager application 135 can also allow the user to create the job model from a previously created job model and/or a predefined library template. For example, the competency manager application 135 can include a plurality of job model templates relating to various jobs (e.g., accountants, paralegals, actuaries, managers, housekeepers). The competency manager application 135 can allow the user to search for a template that may be a good fit for the job model being created. For example, if the user is creating an account executive job model, the user can search the library for similar job templates. Each of the templates can represent a “draft” template from which the user can start. For example, the template can include a list of competencies that the provider of the competency manager application 135 determined are typically important to the particular job to which the template pertains. The templates can also be configured such that the competency subattributes are pre-populated as well.

Upon finding a suitable job model template, the user can create the job model by copying the competencies into the newly created job model (e.g., information from a job model template data structure is copied into the job model data structure). After copying the information from the job model template, the user then can “fine tune” the newly created template-based job model such that it reflects the actual job to be modeled. Additionally, the user can assign individual competencies to subgroups (e.g., “corporate” and “technical”), create new competencies, and can delete competencies.

The competency manager application 135 can also be configured to allow the user to set values for one or more of the competency subattributes (e.g., by updating the job model data structure). Preferably, for each of the competencies associated with a job model, the user can set a proficiency, importance, and weight. In one embodiment of the invention, proficiency can be rated on a zero to four scale:

TABLE 9

| Proficiency Level | Proficiency |
|---|---|
| 0 | No Experience |
| 1 | Basic Understanding |
| 2 | Working Experience |
| 3 | Extensive Experience |
| 4 | Subject Matter Depth and Breadth |

Other proficiency levels are possible. The choices available for the importance subattributes can vary depending on the type of competency (e.g., corporate or technical). For example, the importance can be critical, not critical, low, medium, and/or high. The competency manager application 135 can also be configured to provide the ability for the user to provide a weight to the competencies (e.g., 0-10). The subattributes for a specific competency can be set by the user and/or can be imported from the library maintained on the database 110. Each of the updated subattributes can be saved by updating the job model data structure.

At stage 325, the competency manager application 135 can allow the user to request feedback from one or more members of a workgroup to assist in the creation of the job model. The other members of the workgroup can be colleagues of the user, although a workgroup can include external (e.g., not employees) members. The competency manager application 135 can allow the user to search a corporate address book to identify workgroup members, and to allow the user to input e-mail addresses of outside work group members. The competency manager application 135 can create a workgroup data structure corresponding to the workgroup created by the user.

Each competency within the job model can be assigned one or more members of the workgroup to review, revise, and provide feedback. Thus, for example, feedback can be obtained on a competency-by-competency basis (e.g., different members within the workgroups can provide feedback on different competencies). The competency manager application 135 can update the workgroup data structure to reflect which workgroup member reviews which competencies.

After defining a group of reviewers for a particular competency (or group of competencies) the user can pose a question, provide comments, and/or poll reviewers about the competency. For example, if a user is uncertain about including “Budgeting” as competency within an accounting job model, the user can request feedback from other members of the workgroup regarding whether to include it.

The types of feedback available to the user can vary. The user can send a notification to members of the workgroup that includes comments by the user (e.g., “I will include this competency unless I hear otherwise.”). The notification can take the form of, for example, an e-mail to a member of the workgroup that can be sent by the competency manager application 135. The notification can be configured to direct the workgroup member to a webpage to elicit comments that provide feedback to the user (e.g., the competency manager application 135 can create a webpage for use by the workgroup member). The user can send a voting request to members of the workgroup that includes a customizable polling question. For example, the user can ask members of the workgroup which proficiency level is appropriate, and provide the appropriate voting buttons (e.g., 0, 1, 2, 3, 4). Preferably, the voting request comes in the form of an e-mail sent by the competency manager application 135 that directs the workgroup member to a webpage to provide a response. In either case, the competency manager application 135 can update the workgroup data structures to reflect the feedback requested by the user. Other configurations are possible.

At stage 330, feedback from workgroup members can be received by the user through the competency manager application 135 (e.g., through the home page), and/or can be received through other methods such as an e-mail. For example, the competency manager application 135 can retrieve feedback saved in the workgroup data structure. Upon receiving the feedback from the other workgroup members, the user can decide whether to modify the created job model. For example, if a number of workgroup members feel that a particular competency should not be included, the user can remove it. The competency manager application 135 can also be configured to prevent the user from proceeding to the confirmation and/or approval stages until all feedback is received. If the user decides to revise the job model, the process 300 can proceed to stage 335, otherwise, the process 300 can proceed to the process 400 or the process 500.

At stage 335, the user can modify the job model based upon the feedback received from the workgroup members. For example, the user can add/remove competencies, change subattributes related to one or more of the competencies (e.g., weight, importance, writing assistances, learning references, coaching tips, goal statements, interview questions), change the job title, change the job function, etc. The competency manager application 115 can update the job model data structure based upon the changes made by the user during stage 335. After revising the job model, the process 300 can return to stage 325 where the workgroup is again notified that feedback is requested on the revised job model.

In operation, referring to FIG. 4, with further reference to FIGS. 1-2, a process 400 for confirming a job model can include the stages shown. The process 400, however, is exemplary only and not limiting. The process 400 may be altered, e.g., by having stages added, removed, altered, or rearranged. As discussed above, the process 400 assumes that the user is accessing a web-based application hosted by the server 115 using the computer 125, although other configurations are possible. Furthermore, exemplary screen shots of certain aspects of the process 400 are attached hereto in the appendix.

At stage 405, the competency manager application 135 can allow the user to define a group of stakeholders to participate in the confirmation workflow of the job model. Confirmation can include the solicitation and receipt of feedback from one or more of the stakeholders. The competency manager application 135 can update the confirmation data structure to reflect the group of stakeholders defined by the user. The user can choose between a predefined group of stakeholders, and/or can create a new group consisting of one or more stakeholders who can confirm one or more elements of a job model. The stakeholders can be, for example, peers, subject matter experts, and immediate managers. Stakeholders can be colleagues of the user (e.g., employees of the same company as the user), and/or can be outside specialists (e.g., outside consultants and/or outside legal counsel).

The competency manager application 135 can provide a default confirmation method, and/or a user definable confirmation method. Using the default confirmation method, each of the stakeholders is preferably able to review some or all of the competencies included in a job model, provide a recommended proficiency, provide a recommended weight, provide a recommended importance, and provide an overall recommendation. The stakeholder can also provide written feedback relating to a particular competency. If the competency manager application 135 is configured to use the user definable confirmation methods, the user can request written feedback, and/or set up voting buttons similar to that discussed above with respect to creation of a job model. The competency manager application 135 can update the competency data structure to reflect the feedback requested by the user.

At stage 410, the competency manager application 135 can notify the stakeholders that confirmation is requested by the user. The competency manager application 135 can create and send an e-mail to the individual stakeholders. Preferably, the notification e-mail includes a link to a webpage where the stakeholder is able to view the job model, including some or all of the competencies.

At stage 415, the competency manager application 135 can create and provide a webpage for the reviewing stakeholders to provide feedback. For example, for each of the competencies available to a reviewing stakeholder, the stakeholder can view the competency subattributes (e.g., competency name, competency class, competency type, suggested proficiency, suggested weight, and suggested importance) that are related to a particular competency. The competency manager application 135 can provide the ability for a reviewing stakeholder to make recommended changes to the job model such as recommending a new proficiency, weight, and/or importance. The reviewing stakeholder can also provide a recommendation related to an entire competency such as approve, remove, and/or change. The reviewing stakeholder can also provide written feedback to the user regarding one or more of the competencies and/or the entire job model. The competency manager application 135 can save the feedback received from the stakeholders by updating the confirmation data structure.

At stage 420, the competency manager application 135 can allow the user to review the feedback provided by the stakeholders. The competency manager application 135 can retrieve the feedback stored in the confirmation data structure and provide it to the user via a webpage. The user can view a list of requested feedback and a related status. For example, the user can view a list of stakeholders along with an indicator showing whether the individual stakeholders have provided feedback, when feedback was requested, when the stakeholder viewed a notification sent by the competency manager application 135, when the stakeholder provided feedback, and overall comments by the reviewing stakeholder. The competency manager application 135 can also allow the user to resend a notification to a specific stakeholder requesting feedback.

The competency manager application 135 can allow the user to view competency-specific feedback provided by each of the stakeholders. For example, for each competency, the user is able to view a chart showing the original subattributes (e.g., those set by the user during the creation stage), the recommended (if any) subattributes provided by each reviewing stakeholder, and an overall competency recommendation made by the stakeholder. The competency manager application 135 can also average the feedback provided by multiple stakeholders. For example, if ten different stakeholders each provide recommended weights for a particular competency, the competency manager application 135 can provide statistical analysis (e.g., average, median, mean, mode, etc.) provide the results to the user.

At stage 425, based upon the feedback received from the stakeholders, the user can decide to revise the job model and/or proceed to approval of the job model. If the user decides to revise the job model, the process 400 proceeds to stage 430. The competency manager application 135 can be configured to require feedback from all stakeholders before the user is allowed to proceed to approval. If the user does not revise the job model, the user can advance the job model to the approval stage if permitted. The competency manager application 135 can update the job model data structure and/or the confirmation data structure to reflect that confirmation has occurred.

At stage 430, the user can modify the job model based upon the feedback received from the stakeholders. For example, the user can add/remove competencies, change subattributes related to one or more of the competencies (e.g., weight, importance, writing assistances, learning references, coaching tips, goal statements, interview questions), change the job title, change the job function, etc. The competency manager application 115 can update the job model data structure based upon the changes made by the user during stage 430. After revising the job model at stage 430, the process 400 can proceed to one of several different stages. The process 400 can return to stage 410 where the stakeholders are again notified that feedback is requested on the revised job model. The process 400 can proceed to stage 405 if the user wants to redefine the group of stakeholders from which feedback is requested. The process 400 can proceed to stage 325 of the process 300 if the user wants to request feedback from the workgroup members again.

In operation, referring to FIG. 5, with further reference to FIGS. 1-2, a process 500 for approving a job model can include the stages shown. The process 500, however, is exemplary only and not limiting. The process 500 may be altered, e.g., by having stages added, removed, altered, or rearranged. As discussed above, the process 500 assumes that the user is accessing a web-based application hosted by the server 115 using the computer 125, although other configurations are possible. Furthermore, exemplary screen shots of certain aspects of the process 500 are attached hereto in the appendix.

At stage 505, the competency manager application 135 can allow the user to define a group of approvers to approve the job model. Approval can include the solicitation and receipt of feedback from one or more of the approvers. The competency manager application 135 can update the approval data structure to reflect the group of approvers defined by the user. The user can choose between a predefined group of approvers, and/or can create a new group consisting of one or more approvers who can approve a job model. The approvers can consist of decision-makers within or outside the company for which the user works for. For example, approvers can include C-level employees (e.g., chief executive officer, chief information officer, general counsel) and/or outside legal counsel who represents the user's company (e.g., outside employment counsel).

The competency manager application 135 can provide a default approval method, and/or a user definable approval method. Using the default approval method, each of the approvers is preferably able to review an entire job model, approve/decline the entire job model, and provide written comments to the user. If the competency manager application 135 is configured to use the user definable approval methods, the user can request written feedback, and/or set up voting buttons similar to that discussed above with respect to creation and/or validation of a job model. The competency manager application 135 can update the approval data structure to reflect the feedback requested by the user.

At stage 510, the competency manager application 135 can notify the approvers that approval is requested by the user. The competency manager application 135 can accomplish notification by creating and sending an e-mail to the individual approvers. Preferably, the notification e-mail includes a link to a webpage where the approvers able to view the job model, including some or all of the competencies.

At stage 515, the competency manager application 135 can create and provide a webpage for the approvers to provide feedback. The webpage can be accessed by following a link in a notification e-mail. Upon following the link in the notification e-mail, each of the approvers is able to view the entire job model including all of the attributes, competencies, and competency subattributes. Each of the approvers can also view all of the earlier feedback provided by the various workgroup members and stakeholders. The competency manager application 135 can allow each of the approvers to approve a job model as a whole and/or reject the job model as a whole, although other configurations are possible (e.g., approve/reject part of a job model). Each of the approvers can also be given the ability to provide written feedback to the user. Other types of feedback by the approvers is also possible (e.g., responses to voting questions). The competency manager application 135 can save the feedback received from the approvers in the approval data structure.

At stage 520, the competency manager application 135 can allow the user to review the feedback provided by the approvers. The competency manager application 135 can retrieve the feedback stored in the approval data structure and provide it to the user via a webpage. The user can view a list of requested feedback and related status. For example, the user can view a list of approvers along with an indicator showing whether the individual approvers have provided feedback (e.g., approval), when feedback was requested, when the approver viewed a notification sent by the competency manager application 135, when the approver provided feedback, and overall comments provided by the approvers. The competency manager application 135 can also allow the user to resend a notification to a specific approver requesting feedback.

The competency manager application 135 can allow the user to view the feedback provided by the approvers. For example, the user is able to view a chart showing whether a particular approver approved and/or rejected the job model. The user can use the feedback provided by the approvers to take further action such as modifying the job model based upon feedback.

At stage 525, based upon the feedback received from the approvers, the user can decide to revise the job model and/or proceed to finalization. If the user decides to revise the job model, the process 500 proceeds to stage 530. The competency manager application 135 can use the feedback provided by the approvers in order to determine whether a job model can be finalized and/or published. For example, depending on how a particular job model is configured, the user can be prevented from finalizing and publishing a job model until all approvers approve a particular job model. Alternatively, the user can finalize and publish a job model if a predefined number of approvers approve of the job model (e.g., a majority). In some circumstances, however, user can be allowed to finalize (e.g., stage 220 of the process 200) and publish a job model without any approval whatsoever.

At stage 530, the user can modify the job model based upon the feedback received from the approvers. For example, the user can add/remove competencies, change subattributes related to one or more of the competencies (e.g., weight, importance, writing assistances, learning references, coaching tips, goal statements, interview questions), change the job title, change the job function, etc. The competency manager application 115 can update the job model data structure based upon the changes made by the user during stage 530. After revising the job model at stage 530, the process 500 can proceed to one of several different stages. The process 500 can return to stage 510 where the approvers are again notified that feedback is requested on the revised job model. The process 500 can proceed to stage 505 if the user wants to redefine the group of approvers from which feedback is requested. The process 500 can proceed to stage 325 of the process 300 if the user wants to request feedback from the workgroup members again. Fourth, the process 500 can proceed to stages 405 and/or 410 of the process 400 if the user wants to request feedback from the stakeholders again.

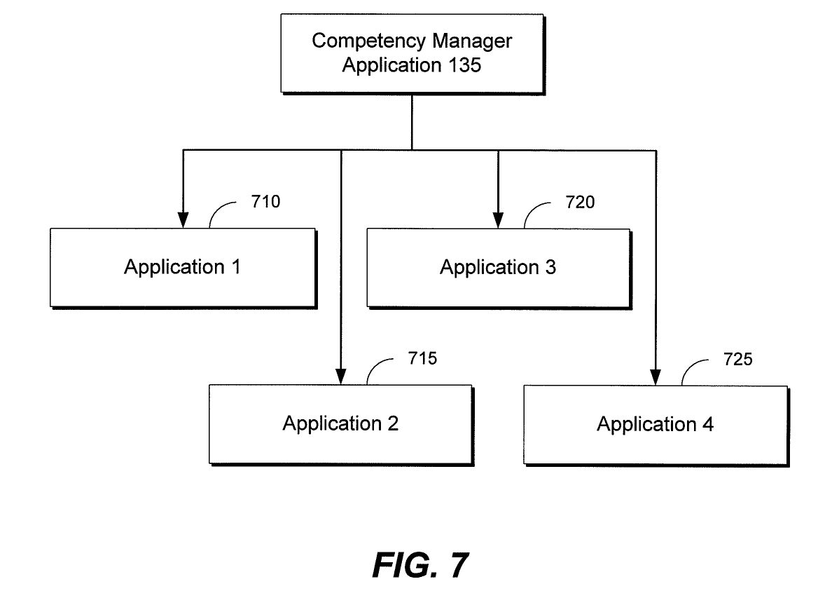

In operation, referring to FIG. 6, with further reference to FIGS. 1-2, and 7, a process 600 for publishing a job model includes the stages shown. The process 600, however, is exemplary only and not limiting. The process 600 may be altered, e.g., by having stages added, removed, altered, or rearranged. As discussed above, the process 600 assumes that the user is accessing a web-based application hosted by the server 115 using the computer 125, although other configurations are possible. Furthermore, exemplary screen shots of certain aspects of the process 600 are attached hereto in the appendix.

At stage 605, the competency manager application 135 can allow the user to publish the job model to one or more other applications such as applications 710, 715, 720, 725 (which can be any one of the applications 160, 165, 170 shown in FIG. 1). Applications that can be used with the competency manager application 135 can vary, but typically are other human resource-related applications. The user can choose to publish a job model to one or more of the available applications using the competency manager application 135. The competency manager application 135 can provide the user with a list of applications to which the job model can be published. The user can select the desired applications from the list. Preferably, publication occurs on a job model-by-job model basis, although other configurations are possible. Multiple job models, or parts thereof, can be published simultaneously. The competency manager application 135 can update the job model data structure to indicate which applications the job model is published to.

At stage 610, the competency manager application 135 can filter the job models prior to publication to a particular selected application. For example, the competency manager application 135 can selectively remove parts of the job model data structure to avoid sending unnecessary information to the applications 710, 715, 720, 725. Filtering can be desirable when an application does not need all of the competencies included in the job model. For example, an applicant tracking system can use a different subset of competencies from a performance management application. In this manner each of the applications 710, 715, 720, 725 can receive different portions of the job model via publication.

At stage 615, the competency manager application 135 can publish the filtered and/or unfiltered job models to the applications 710, 715, 720, 725. Publishing job models to the other applications can be accomplished using various methods. For example, the user can export (e.g., download) a job model from the competency manager application 135, via the network 120, and import the job model into another application (e.g., by uploading the job model to the other application). The competency manager application 135 can also be configured to send a job model directly to another application (e.g., via the network 120 and/or through a dedicated connection). The competency manager application 135 can publish job models at the request of the user, and/or at regular predetermined intervals (e.g., quarterly). Furthermore, the competency manager application 135 can also export a job model as a Microsoft Excel file, an XML file, a text file, and/or a proprietary format file.

The competency manager application 135 can provide the user with the option to archive a job model after publishing it. When archiving the job model, the user can choose whether the job model will be searchable, exportable, and/or publishable at a later time. The archiving process can also include setting a date on which a job model is automatically deleted.

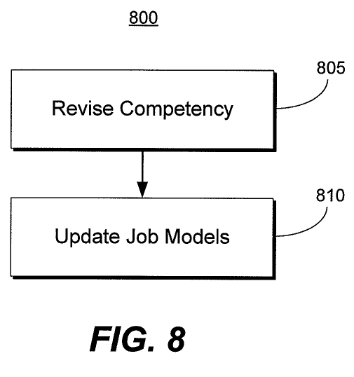

In operation, referring to FIG. 8, with further reference to FIGS. 1-2, a process 800 for updating competencies includes the stages shown. The process 800, however, is exemplary only and not limiting. The process 800 may be altered, e.g., by having stages added, removed, altered, or rearranged. As discussed above, the process 800 assumes that the user is accessing a web-based application hosted by the server 115 using the computer 125, although other configurations are possible. Furthermore, exemplary screen shots of certain aspects of the process 600 are attached hereto in the appendix.

At stage 805, the competency manager application 135 can provide the ability to update a competency. Updating a competency can include updating a competency that is stored on the database 110, the server 115, the competency manager application 135, the computer 125, and/or the database 130. The update of the competency can be performed by multiple people and/or groups. For example, the provider of the competency manager application 135 and/or the user can update any given competency. Competencies can be updated at any time and for numerous reasons such as recent legal developments. The competency manager application 135 is configured to update one or more corresponding job model data structures when changes are made to a competency.

At stage 810, the competency manager application 135 can update one or more job models that use the updated competencies. The update process can vary depending on a number of factors. In one embodiment of the invention, if the user updates a competency (whereby the update is only applicable to the company in which the user is employed) the user can be given the option to automatically update some or all of the job models that include the updated competency. In another embodiment of the invention, if the provider of the competency manager application 135 updates a competency, the provider can automatically “push” updates to users of competency manager application 135 (e.g., by pushing updated competency data structures to the computer 125). The pushed updates can occur automatically, and can occur at predetermined intervals (e.g., quarterly). The pushed updates include a notification to the user that a competency has been updated, thereby allowing the user to determine whether to further update all of the job models that use the updated competency. In either case, the competency manager application 135 can be configured such that the updating of a competency triggers a new round of review by workgroup members, stakeholders, and/or approvers.

Other embodiments are within the scope and spirit of the invention.

The subject matter described herein can be implemented in digital electronic circuitry, or in computer software, firmware, or hardware, including the structural means disclosed herein and structural equivalents thereof, or in combinations of thereof. The subject matter described herein can be implemented as one or more computer program products, such as one or more computer programs tangibly embodied in an information carrier (e.g., in a machine readable storage device or in a propagated signal), for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. For example, the computer programs and applications discussed herein can be implemented using Microsoft .Net, C, C++, Java, SQL, PHP, Visual Basic, Pearl, Python, JavaScript, and C#. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data (e.g., a computer readable medium) include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry. Furthermore, the memories, databases, data stores, and other storage mediums discussed herein can all be configured to store data objects that include, for example, a data field and associated data.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

While the present disclosure discusses certain pieces of hardware performing and/or executing certain functionality, one or more functional aspects described herein can be combined into a single piece of hardware. For example, the database 110, the server 115, the computer 125, and the database 130 (or any combination thereof) can be combined into a single hardware unit or distributed over several hardware units.

It is noted that one or more references are incorporated herein. To the extent that any of the incorporated material is inconsistent with the present disclosure, the present disclosure shall control. Furthermore, to the extent necessary, material incorporated by reference herein should be disregarded if necessary to preserve the validity of the claims.

It is also noted that the “job model” discussed herein is also sometimes referred to herein as a “job profile.”

Further, while the description above refers to the invention, the description may include more than one invention.

What is claimed is:

1. An apparatus for managing a job model workflow, the apparatus comprising:
a server computer including a processor and associated memory;
a data store;
the server computer connected to the data store and configured to execute computer readable instructions that, when executed, cause the server computer provide an application that can:
receive from a user a request to create a job model;
create a job model data structure in the data store corresponding to the job model;
populate the data structure with a first data object representing one or more attributes of the job model;
notify another user that feedback relating to the one or more attributes of the job model is requested;
provide an interface for the another user to provide feedback;
store received feedback in the data store; and
provide the received feedback to the user.

2. The apparatus of claim 1 wherein the one or more attributes are representative of a competency.

3. The apparatus of claim 1 wherein the one or more attributes are representative of a plurality of competencies and wherein the computer readable instructions cause the server computer to provide an application that can notify the another user that feedback is requested with respect to a subset of the plurality of competencies.

4. The apparatus of claim 1 wherein the data store includes a data structure including information representing a job model template, wherein the computer readable instructions cause the server computer to provide an application that can populate the job model data structure using at least part of the information representing the job model template.

5. The apparatus of claim 1 wherein the computer readable instructions cause the server computer to provide an application that can provide the user with the ability to define the feedback requested from the another user.

6. The apparatus of claim 5 wherein the computer readable instructions cause the server computer to provide an application that can provide the user with the ability to create a polling question relating to the attributes.

7. The apparatus of claim 1 wherein the computer readable instructions cause the server computer to provide an application that can finalize the job model.

8. The apparatus of claim 1 wherein the computer readable instructions cause the server computer to provide an application that can publish at least a portion of the job model.

9. The apparatus of claim 1 wherein the computer readable instructions cause the server computer to provide an application that can provide the user with the ability to revise the attribute as a function of the received feedback.

10. The apparatus of claim 9 wherein the computer readable instructions cause the server computer to provide an application that can notify the another user that feedback relating to the revised attribute is requested.

11. A computerized method relating to a job model, the method comprising:
providing a sever computer, associated memory, and a data store coupled to the server computer;
creating a data structure related to the job model in the data store;
populating the data structure with a first data object representing an attribute of the job model;
creating a feedback request requesting feedback relating to the attribute;
receiving feedback relating to the attribute;
updating the data structure to include a second data object representing the received feedback;
updating the first data objects as a function of the received feedback; and
publishing at least a portion of the data structure to an application.

12. The computerized method of claim 11 wherein the attribute is representative of a competency.

13. The computerized method of claim 11 wherein the attribute is a plurality of competencies and the creating the feedback request includes requesting feedback relating to a subset of competencies.

14. The computerized method of claim 11 further comprising maintaining a second data structure in the data store that includes information representing a job model template.

15. The computerized method of claim 14 wherein populating the data structure includes populating the data structure using at least a portion of the information contained in the second data structure.

16. The computerized method of claim 11 further comprising defining the requested feedback.

17. The computerized method of claim 16 wherein defining the requested feedback includes creating a polling question relating to the attribute.

18. The computerized method of claim 11 populating the data structure with a third data object that reflects a status of the job model.

19. A computer readable medium for storing data for access by an application program executed on a processor, the computer readable medium comprising:
a data structure stored in the computer readable medium, the data structure relating to a job model and including information used by the application program including:
a first data object representing an identifier associated with the job model;
a second data object representing a competency associated with the job model;
a third data object representing a subattribute associated with the competency; and
a fourth data object representing a level of completion associated with the job model.

20. The computer readable medium of claim 19, wherein the level of completion is at least one of draft, validation in process, validated, approval in process, approved, declined, and archived.

21. The computer readable medium of claim 19, further comprising a fifth data object representing feedback received from a user relating to at least one of the competency and the subattribute.

22. The computer readable medium of claim 19, wherein the fourth data object is updated in response to receiving feedback from a user.

23. The computer readable medium of claim 19, further comprising a sixth data object representing publication information related to the subattribute.

24. An apparatus for managing a job model workflow, the apparatus comprising:
a server computer including a processor and associated memory, the server computer hosting an application;
a data store coupled to the server;
a client computer including a processor and associated memory coupled to the server computer through a network, the client computer being configured to execute computer readable instructions that, when executed, cause the client computer to access the server computer;
wherein the server computer executes computer readable instructions that, when executed, cause the server computer to provide an application that can:
receive from a user a request to create a job model;
create a job model data structure in the memory corresponding to the job model;
populate the data structure with a first data object representing one or more attributes of the job model;
notify another user that feedback relating to the one or more attributes of the job model is requested;
provide an interface for the another user to provide feedback;
store received feedback in the memory; and
provide the received feedback to the user.
